(19) United States
(12) Patent Application Publication
(10) Pub. No.: US 2012/0194455 A1
(43) Pub. Date: Aug. 2, 2012

(54) TABLET ELECTRONIC DEVICE

(75) Inventors: Ming-Fang Hsu, Taipei City (TW); Ming-Chih Hsieh, Taipei City (TW); Lian-Tien Ke, Taipei City (TW)

(73) Assignee: ASUSTEK COMPUTER INC., Taipei City (TW)

(21) Appl. No.: 13/349,587

(22) Filed: Jan. 13, 2012

Related U.S. Application Data
(60) Provisional application No. 61/437,009, filed on Jan. 28, 2011.

(51) Int. Cl. G06F 3/041

(52) U.S. Cl. 345/173

(57) ABSTRACT

A tablet electronic device configured to electrically connect to a portable electronic device is provided. The portable electronic device includes a first connecting interface and a processing module. The tablet electronic device includes a body and a touch panel. The body includes a second connecting interface connected to the first connecting interface. The touch panel is disposed in the body to generate a touch signal after a touch, and when the portable electronic device is connected to the tablet electronic device, the touch panel displays information of the portable electronic device.

### CROSS-REFERENCE TO RELATED APPLICATION

This application claims the priority benefit of U.S. provisional application Ser. No. 61/437,009, filed on Jan. 28, 2011. The entirety of the above-mentioned patent application is hereby incorporated by reference herein and made a part of this specification.

### BACKGROUND OF THE INVENTION

1. Field of the Invention

The invention relates to an electronic device and, more particularly, to a tablet electronic device configured to electrically connect to a portable electronic device.

2. Description of the Related Art

A smart phone can be used to browse websites and edit documents except the communication function. The smart phone is portable and smaller than other handheld electronic devices. However, the size of its screen is also limited, which is difficult for the user to operate with.

If the user needs a handheld device with a larger screen, a tablet computer is available. However, most of the tablet computers do not include a communication module, and the size of the tablet computer is larger than the smart phone so as to occupy more space and is not convenient for portability.

Furthermore, since the operation systems of various handheld electronic devices are different, when the user transmits data between the handheld electronic devices, the handheld electronic devices may be not compatible with each other.

### BRIEF SUMMARY OF THE INVENTION

A tablet electronic device configured to electrically connect to a portable electronic device is disclosed. The user can operate the portable electronic device conveniently via the tablet electronic device.

A tablet electronic device is configured to electrically connect to a portable electronic device. The electrical connection or a data exchange may be a physical or unphysical electrical connection.

The portable electronic device includes a first connecting interface and a processing module. The tablet electronic device includes a body and a touch panel. The body includes a second connecting interface connected to the first connecting interface. The touch panel is disposed in the body and generates a touch signal after a touch. When the portable electronic device is connected to the tablet electronic device, the touch panel displays information of the portable electronic device. The touch signal is transmitted to the first connecting interface via the second connecting interface. After the touch signal is processed by the processing module, the processing module generates output information and transmits it to the second connecting interface via the first connecting interface, and the output information is displayed at the touch panel.

As stated above, the portable electronic device can be operated via the touch panel of the tablet electronic device. Since the tablet electronic device utilize the processor of the portable electronic device, no processing module is required in the tablet electronic device, which decreases manufacture cost. Moreover, no matter the portable electronic device is used by users directly, or the information of the portable electronic device is read via the tablet electronic device, the operation system of the portable electronic device can be utilized in any conditions, which avoids the troublesome in data conversion between different operation systems.

These and other features, aspects and advantages of the present invention will become better understood with regard to the following description, appended claims, and accompanying drawings.

### BRIEF DESCRIPTION OF THE DRAWINGS

FIG. 1A is a back view showing a tablet electronic device and a portable electronic device in a first embodiment;

FIG. 1B is a back view showing that the tablet electronic device in FIG. 1A is connected to the portable electronic device;

FIG. 1C is a front view showing that the tablet electronic device in FIG. 1A is connected to the portable electronic device;

FIG. 2 is a front view showing that a tablet electronic device is connected to a portable electronic device in a second embodiment;

FIG. 3 is a back view showing that a tablet electronic device is connected to a portable electronic device in a third embodiment;

FIG. 4A and FIG. 4B are back view showing a tablet electronic device in a fourth embodiment;

FIG. 4C is a back view showing the tablet electronic device and the portable electronic device in FIG. 4A;

FIG. 4D to FIG. 4E are back view showing that the tablet electronic device in FIG. 4A is connected to the portable electronic device;

FIG. 5 is a back view showing that a tablet electronic device is connected to a portable electronic device in a fifth embodiment;

FIG. 6 is a back view showing that a tablet electronic device is wirelessly connected to a portable electronic device in a sixth embodiment;

FIG. 7 is a back view showing that a tablet electronic device is connected to a portable electronic device in a seventh embodiment; and

FIG. 8 is a back view showing that a tablet electronic device is connected to a portable electronic device in an eighth embodiment.

### DETAILED DESCRIPTION OF THE EMBODIMENTS

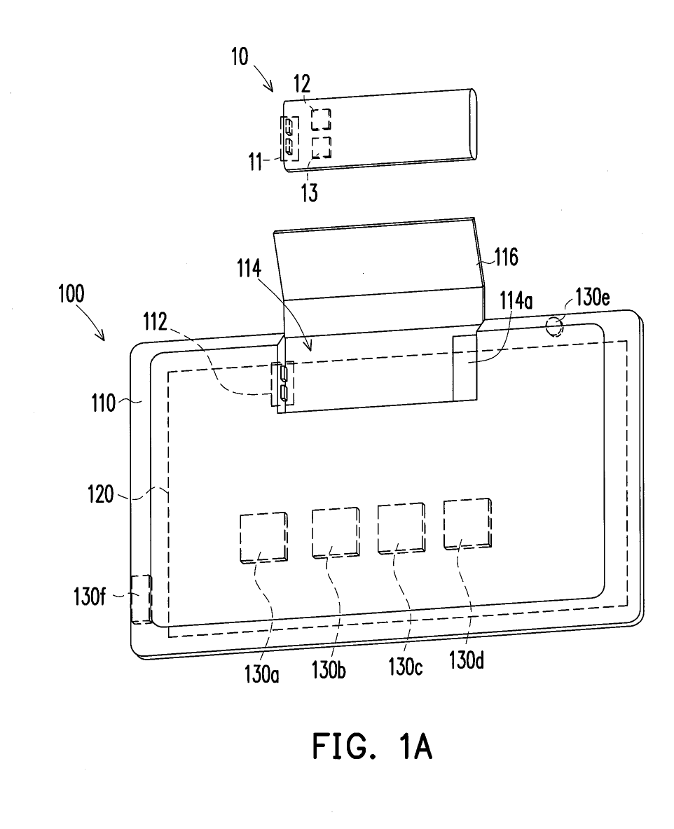

FIG. 1A is a back view showing a tablet electronic device and a portable electronic device in a first embodiment. FIG. 1B is a back view showing that the tablet electronic device in FIG. 1A is connected to the portable electronic device. FIG. 1C is a front view showing that the tablet electronic device in FIG. 1A is connected to the portable electronic device.

In FIG. 1A to FIG. 1C, the tablet electronic device 100 is electrically connected to the portable electronic device 10, and the electrical connection or data exchange may be a physical or unphysical, which is not limited herein. The portable electronic device 10 includes a first connecting interface 11, a processing module 12 and an image modulating module 13. The portable electronic device 10 may be a mobile phone, which is not limited herein.

The tablet electronic device 100 includes a body 110, a touch panel 120, a power source module 130a, a loudspeaker module 130b, a radio module 130c, an antenna module 130d, a lens 130e and an extension interface 130f. The components of the tablet electronic device 100 are just for examples and can be adjusted according to requirements, which is not limited herein.

The body 110 includes a second connecting interface 112 connected to the first connecting interface 11. The touch panel 120 is disposed in the body 110 and generates a touch signal while being touched thereon. When the portable electronic device 10 is connected to the tablet electronic device 100, the touch panel 120 displays the information of the portable electronic device 10.

The touch signal is transmitted to the first connecting interface 11 via the second connecting interface 112 and processed by the processing module 12. Then, the processing module 12 generates output information, and the output information is transmitted to the second connecting interface 112 via the first connecting interface 11 and is displayed at the touch panel 120.

The body 110 includes an accommodating recess 114 and a protection cover 116, and the protection cover 116 movably covers the accommodating recess 114. When the portable electronic device 10 is accommodated in the accommodating recess 114, the protection cover 116 covers the portable electronic device 10 to keep a consistent outlook of the tablet electronic device 100. However, the protection cover 116 may be omitted.

The accommodating recess 114 may include a sliding runner 114a disposed in the accommodating recess 114. When the portable electronic device 10 is disposed in the tablet electronic device 100 along the sliding runner 114a, the first connecting interface 11 is connected to the second connecting interface 112.

The first connecting interface 11 and the second connecting interface 112 may be physical connecting ports, such as a micro universal serial bus (Micro USB) or a micro high definition multimedia interface (Micro HDMI). The portable electronic device 10 and the tablet electronic device 100 are electrically connected and transmit signals to each other via the micro USB and the micro HDMI.

In an embodiment, the tablet electronic device 100 does not include a central processing unit (CPU) or a graphic processing unit (GPU). When the first connecting interface 11 of the portable electronic device 10 is connected to the second connecting interface 112 of the tablet electronic device 100, the signals of the portable electronic device 10 can be transmitted to the tablet electronic device 100. Moreover, the touch panel 120 is larger than the screen of the portable electronic device 10, and thus it is convenient for the user to operate the portable electronic device 10 via the touch panel 120.

Furthermore, before the output information, such as image information, of the portable electronic device 10 is transmitted to the tablet electronic device 100, the image modulating module 13 adjusts the definition of the image information to fit the touch panel 120. Then the adjusted image information is transmitted to the second connecting interface 112 of the tablet electrical device 100 via the first connecting interface 11 and displayed at the touch panel 120.

The power source module 130a is disposed in the body 110 and is electrically connected to the second connecting interface 112 and the touch panel 120. When the portable electronic device 10 is connected to the tablet electronic device 100, the power source module 130a may charge the portable electronic device 10 according to requirements.

The loudspeaker module 130b is disposed in the body 110 and is electrically connected to the second connecting interface 112 and the power source module 130a. When the portable electronic device 10 is electrically connected to the tablet electronic device 100, a sound signal of the portable electronic device 10 can be transmitted to the tablet electronic device 100 and played by the loudspeaker module 130b.

The radio module 130c is disposed in the body 110 and is electrically connected to the second connecting interface 112 and the power source module 130a. When the portable electronic device 10 is electrically connected to the tablet electronic device 100, the sound signal received by the radio module 130c is transmitted to the portable electronic device 10 for processing.

The antenna module 130d is disposed in the body 110 and is electrically connected to the second connecting interface 112 and the power source module 130a. When the portable electronic device 10 is electrically connected to the tablet electronic device 100, the antenna module 130d can strengthen the signal of the communication module in the portable electronic device 10.

The lens 130e is disposed in the body 110 and is electrically connected to the second connecting interface 112 and the power source module 130a. When the portable electronic device 10 is electrically connected to the tablet electronic device 100, the image information captured by the lens 130e is transmitted to the processing module 12, and after processing, the processing module 12 generates the output information and transmits it to the touch panel 120 for displaying.

The extension interface 130f is disposed in the body 110 and is electrically connected to the second connecting interface 112 and the power source module 130a. The extension interface 130f may be a USB, which is not limited herein. An external memory device can be connected to the portable electronic device 10 via the extension interface 130f of the tablet electronic device 100.

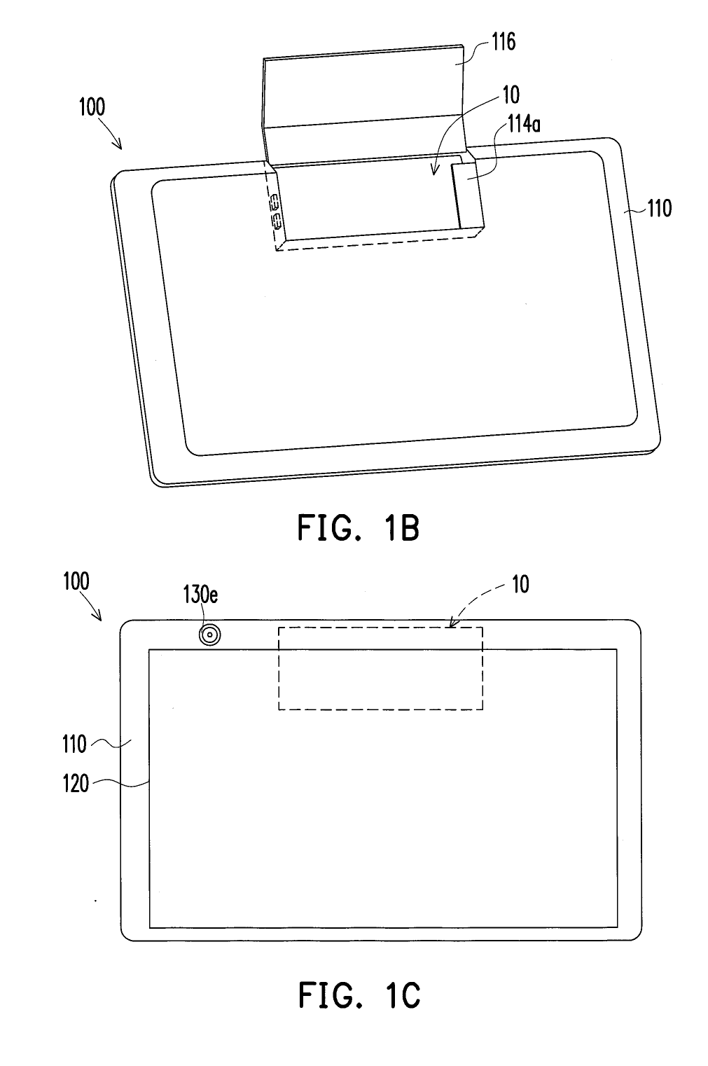

FIG. 2 is a front view showing that a tablet electronic device is connected to a portable electronic device in a second embodiment. The portable electronic device 10 further includes a lens 14, and the body 210 of the tablet electronic device 200 includes a through hole 218. When the first connecting interface 11 is connected to the second connecting interface 212, the position of the lens 14 corresponds to the position of the through hole 218 to expose the lens 14 from the tablet electronic device 200.

As shown in FIG. 2, the tablet electronic device 200 uses the lens 14 of the portable electronic device 10 to capture images, and the captured images can be transmitted to the touch panel 220 for displaying via the first connecting interface 11 and the second connecting interface 212. Thus, the tablet electronic device 200 does not need to include a lens, and the manufacture cost is decreased.

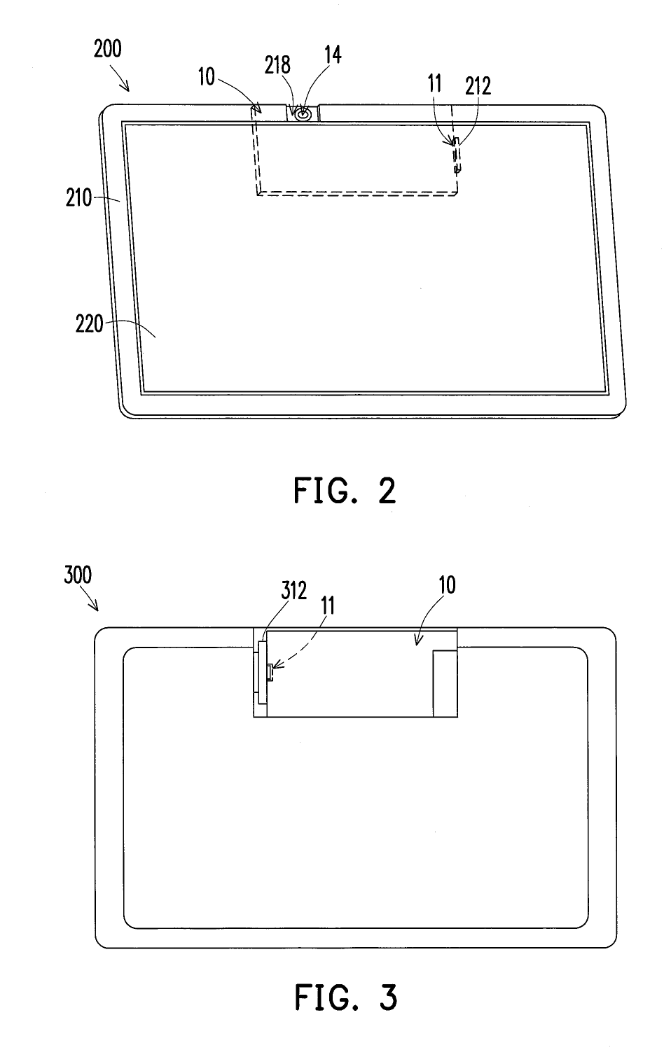

FIG. 3 is a back view showing that a tablet electronic device is connected to a portable electronic device in a third embodiment. The second connecting interface 312 is detachably connected to the body 310. The second connecting interface 312 is an adapter and includes interfaces corresponding to the tablet electronic device 100 and the first connecting interface 11, respectively.

Since different portable electronic devices include different first connecting interfaces, the portable electronic device 10 can be electrically connected to the tablet electronic device 300 via an appropriate second connecting interface 312. Thus, the tablet electronic device 300 can be applied to more types of portable electronic devices.

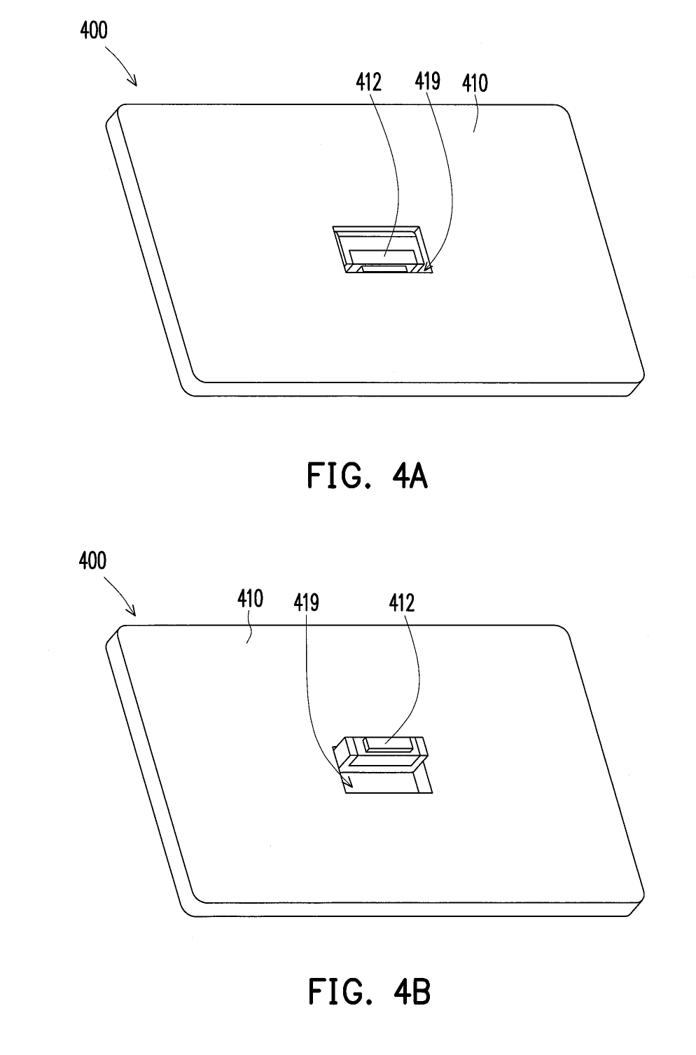

FIG. 4A and FIG. 4B are back view showing a tablet electronic device in a fourth embodiment. The second connecting interface 412 is pivotally connected to the body 410, and it can rotate relative to the body 410. The body 410 includes a recess 419, and the second connecting interface 412 is at the recess 419. As shown in FIG. 4A, when the portable electronic device 10 is not connected to the tablet electronic device 400, the second connecting interface 412 is hidden in the recess 419. To connect the portable electronic device 10 to the tablet electronic device 400, the second connecting interface 412 is rotated outwards (as shown in FIG. 4B).

FIG. 4C is a back view showing the tablet electronic device and the portable electronic device in FIG. 4A. The second connecting interface 412 is exposed from the recess 419, and the first connecting interface 11 of the portable electronic device 10 is directly connected to the second connecting interface 412.

FIG. 4D to FIG. 4E are back view showing that the tablet electronic device in FIG. 4A is connected to the portable electronic device. Since the second connecting interface 412 can rotate relative to the body 410, the portable electronic device 10 connected to the second connecting interface 412 can also rotate relative to the body 410 and be used as a support for the tablet electronic device 400.

Moreover, the portable electronic device 10 further includes a first magnetic element 15, and the tablet electronic device 400 further includes a second magnetic element 440. When the portable electronic device 10 is not used as the support, the portable electronic device 10 flatly faces to the tablet electronic device 400 (as shown in FIG. 4D). The first magnetic element 15 of the portable electronic device 10 attaches to the second magnetic element 440 of the tablet electronic device 400 to make the portable electronic device 10 contemporarily fixed at the tablet electronic device 400.

When the user uses the portable electronic device 10 to support the tablet electronic device 400, he or she only needs to apply force to separate the portable electronic device 10 and the tablet electronic device 400.

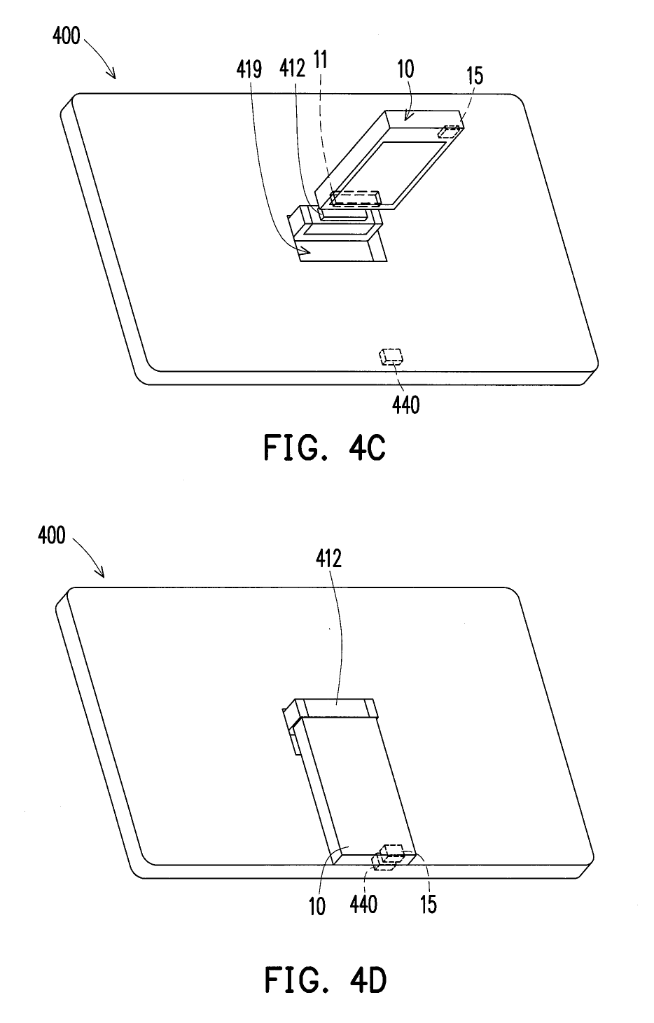

FIG. 5 is a back view showing that a tablet electronic device is connected to a portable electronic device in a fifth embodiment. In the tablet electronic device 500, the first connecting interface 11 is connected to the second connecting interface 512 via a transmission line 20, and the first connecting interface 11 and the second connecting interface 512 may be the same or different transmission interfaces. As shown in FIG. 5, the portable electronic device 10 is outside the tablet electronic device 500.

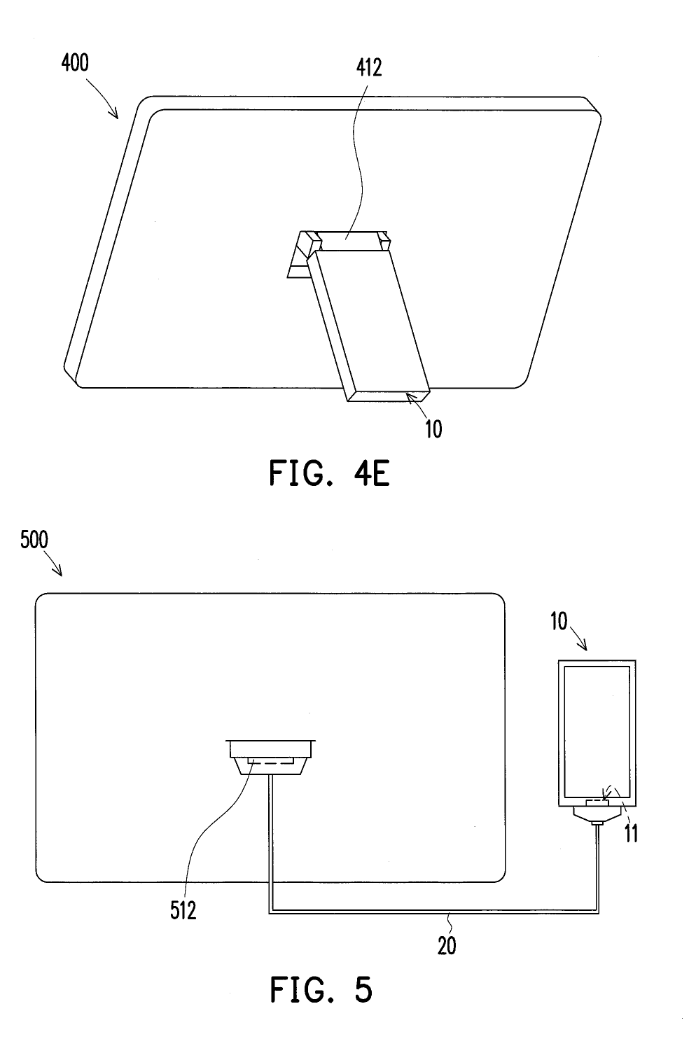

FIG. 6 is a back view showing that a tablet electronic device is wirelessly connected to a portable electronic device in a sixth embodiment. The first connecting interface 11 and the second connecting interface 612 may be unphysical connecting interfaces. For example, the tablet electronic device 600 and the portable electronic device 10 transmit the signal to each other via a wireless transmission module. As shown in FIG. 6, the portable electronic device 10 does not contact with the tablet electronic device 600.

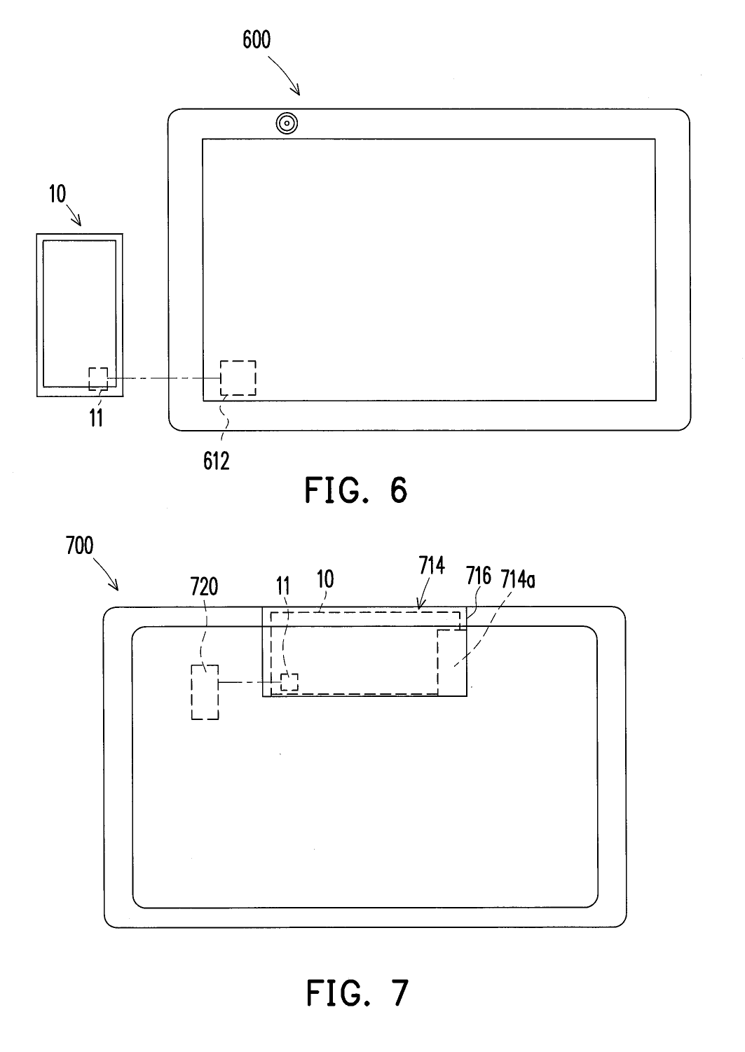

FIG. 7 is a back view showing that a tablet electronic device is connected to a portable electronic device in a seventh embodiment. The difference between the seventh embodiment and the sixth embodiment is that the body of the tablet electronic device 700 includes an accommodating recess 714 and a protection cover 716.

The tablet electronic device 700 uses the accommodating recess 714 to accommodate the portable electronic device 10 and uses the protection cover 716 to cover the portable electronic device 10, which can prevent external objects from entering the tablet electronic device 700 and keep a consistent outlook. Furthermore, it is convenient to carry the portable electronic device 10 and the tablet electronic device 700.

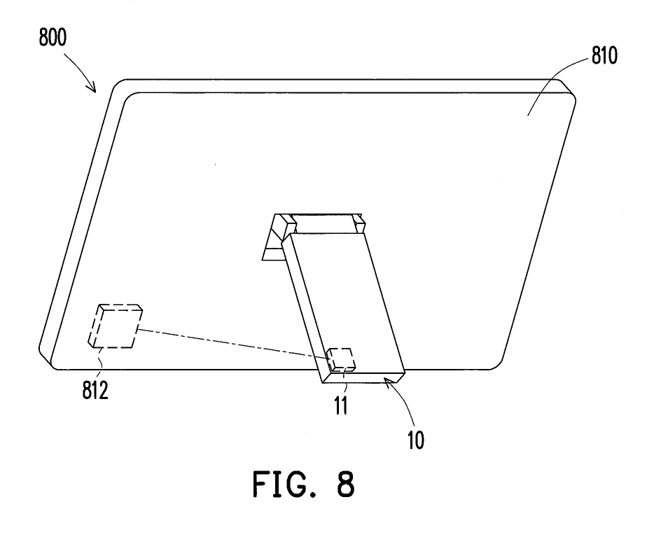

FIG. 8 is a back view showing that a tablet electronic device is connected to a portable electronic device in an eighth embodiment. The difference between the eighth embodiment and the sixth embodiment is that the portable electronic device 10 is pivotally connected to the body 810 and can rotate relative to the body 810. Thus, the portable electronic device 10 can be used as a support for the tablet electronic device 800.

In sum, the touch panel, in a bigger size, of the tablet electronic device is used to operate the portable electronic device, so as to provide a more comfortable operation interface for the user. Moreover, since the portable electronic device is used to process information, the tablet electronic device does not need to include a processing module, which can decrease the manufacture cost and avoid the data conversion problem due to different operation systems.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A tablet electronic device configured to electrically connect to a portable electronic device, wherein the portable electronic device have a first connecting interface and a processing module, the tablet electronic device comprising:
a body including a second connecting interface configured to connect the first connecting interface; and
a touch panel disposed on the body and generating a touch signal while being touched,
wherein when the portable electronic device is connected to the tablet electronic device, the touch signal transmitted to the first connecting interface via the second connecting interface after the touch signal is processed by the processing module, the processing module generates output information and transmits the output information to the second connecting interface via the first connecting interface, and the output information of the portable electronic device is displayed at the touch panel.

2. The tablet electronic device according to claim 1, wherein the body includes an accommodating recess for accommodating the portable electronic device.

3. The tablet electronic device according to claim 2, wherein the accommodating recess includes a sliding runner, and the portable electronic device is disposed in the tablet electronic device along the sliding runner.

4. The tablet electronic device according to claim 2, wherein the body includes a protection cover for covering the accommodating recess.

5. The tablet electronic device according to claim 1, wherein the second connecting interface is detachably connected to the body.

6. The tablet electronic device according to claim 1, wherein the second connecting interface is pivotally connected to the body.

7. The tablet electronic device according to claim 1, wherein the body includes a through hole, the portable electronic device further includes a lens, and when the first connecting interface is connected to the second connecting interface, the position of the lens corresponds to the position of the through hole.

8. The tablet electronic device according to claim 1, wherein the portable electronic device further includes an image modulating module.

9. The tablet electronic device according to claim 1, wherein the tablet electronic device or the portable electronic device further includes a wireless transmission module.
